(19) United States
(12) Patent Application Publication
(10) Pub. No.: US 2021/0190522 A1
(43) Pub. Date: Jun. 24, 2021

(54) VEHICLE EFFICIENCY EVALUATION SYSTEM, IN-VEHICLE DEVICE, MANAGEMENT EXECUTION DEVICE, AND APPLICATION PROGRAM

(71) Applicant: TOYOTA JIDOSHA KABUSHIKI KAISHA, Toyota-shi (JP)

(72) Inventors: Yosuke HASHIMOTO, Nagakute-shi (JP); Akihiro KATAYAMA, Toyota-shi (JP); Yuta OSHIRO, Nagoya-shi (JP); Kazuki SUGIE, Toyota-shi (JP); Naoya OKA, Nagakute-shi (JP)

(73) Assignee: TOYOTA JIDOSHA KABUSHIKI KAISHA, Toyota-shi (JP)

(21) Appl. No.: 17/119,206

(22) Filed: Dec. 11, 2020

(30) Foreign Application Priority Data
Dec. 23, 2019 (JP) 2019-231146

(51) Int. Cl. G01C 21/34; G06Q 30/02; G07C 5/08; G07C 5/00; G06F 8/65

(52) U.S. Cl. CPC G01C 21/3469; G06Q 30/0207; G06F 8/65; G07C 5/008; G07C 5/0816

(57) ABSTRACT

A controller transmits a fuel-economy variable, which corresponds to a travelled distance by a unit fuel amount, to a vehicle group managing device. When the fuel-economy variable is greater than or equal to a reference value, the vehicle group managing device determines that a user is a good driver. When updating software installed in the controller, the vehicle group managing device discounts the billing amount for purchasing the updated version of the software.

### BACKGROUND

### 1. Field

The present disclosure relates to a vehicle efficiency evaluation system, an in-vehicle device, a management execution device, and an application program.

### 2. Description of Related Art

Japanese Laid-Open Patent Publication No. 2012-118783 discloses a system that obtains fuel economy of each vehicle through a predetermined process and makes a ranking of vehicles on fuel economy.

The system of the above document does not overly motivate users to improve the fuel economy. There is thus insufficient motivation to encourage users to perform environmentally friendly driving.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a first general aspect, a vehicle efficiency evaluation system includes a first execution device mounted on a vehicle, and a second execution device that is an out-of-vehicle device. The first execution device is configured to execute: an obtaining process that obtains a consumption variable, which is related to energy consumption of the vehicle, and a traveled distance variable, which is related to a traveled distance of the vehicle; and a variable transmitting process that transmits, to outside of the vehicle, an efficiency variable that corresponds to the consumption variable and the traveled distance variable, together with an identification variable of a user. The second execution device is configured to execute: a variable receiving process that receives the efficiency variable and the identification variable; a determination process that determines, on a basis of the efficiency variable, whether an energy use efficiency of the user identified by the identification variable meets a predetermined standard; and a reward-providing process that provides a reward to the user identified by the identification variable when the energy use efficiency of the user meets the predetermined standard.

When the user performs driving of which the energy use efficiency meets the predetermined standard, the above-described configuration provides the user with a reward for excellent driving of a high energy use efficiency. As compared to a case in which a reward is not provided, the user is motivated to perform driving of which the energy use efficiency meets the predetermined standard. The above-described configuration therefore sufficiently encourages the user to perform environmentally friendly driving.

The phrase “the second execution device that is an out-of-vehicle device” means that the second execution device is not an in-vehicle device.

In the above-described vehicle efficiency evaluation system, the reward-providing process preferably includes a notification process that notifies the user that a billing amount of an object provided to the user is discounted and a reason for the discount, and the provided object preferably includes at least one of a product or a service.

The above-described configuration notifies the user that the billing amount of the product or the service will be discounted and the reason for the discount, allowing the user to recognize the fact that he/she will enjoy the discount of the billing amount of the product or the service as the result of the driving he/she performed. Thus, the above-described configuration strongly motivates the user to try to perform driving of which the energy use efficiency meets the predetermined standard in the future.

In the above-described vehicle efficiency evaluation system, the second execution device is preferably configured to execute a software providing process that provides software to the vehicle, and the reward-providing process preferably includes a process that discounts a billing amount of the software. The first execution device is preferably configured to execute a software receiving process that receives the software provided by the software providing process.

The above-described configuration allows a user who has performed driving of which the energy use efficiency meets the predetermined standard to acquire paid software at a reduced price. This strongly motivates the user to try to perform driving of which the energy use efficiency meets the predetermined standard in the future.

In the above-described vehicle efficiency evaluation system, the second execution device is preferably configured to execute a software providing process that provides an updated version of software to the vehicle. The reward-providing process preferably includes a process that advances a time point of providing the software by the software providing process as compared to a user of whom the energy use efficiency is determined to fail to meet the predetermined standard. The first execution device is preferably configured to execute a software receiving process that receives the software provided by the software providing process.

The above-described configuration provides a user who has performed driving of which the energy use efficiency meets the predetermined standard with an updated version of the software prior to the release, so that the user recognizes that the driving he/she performed was positively evaluated. This strongly motivates the user to try to perform driving of which the energy use efficiency meets the predetermined standard in the future.

In the above-described vehicle efficiency evaluation system, the second execution device is preferably configured to execute a storing process that stores a combination of a determination result and the identification variable in a memory device when the energy use efficiency of the user meets the predetermined condition. The reward-providing process preferably provides a reward on a basis of the determination result stored in the memory device, and the determination result stored in the memory device is preferably associated with the user even when the user changes vehicles.

With the above-described configuration, when the user changes vehicles, the evaluation results acquired through driving of the vehicle prior to the change is retained. Thus, the correspondence between the user and his/her driving skills can be established independently of the vehicles.

In the above-described vehicle efficiency evaluation system, the obtaining process preferably includes an identifying process that identifies whether a road on which the vehicle is traveling is a general road or an expressway. If an amount of energy required for the vehicle to travel a unit distance is the same, the energy use efficiency is preferably higher in a case in which the vehicle is traveling on a general road than in a case in which the vehicle is traveling on an expressway.

In general, a driver is forced to decelerate more often when driving on a general road than when driving on an expressway. The energy use efficiency thus tends to lower on general roads. Accordingly, with the above-described configuration, if the amount of energy required for the vehicle to travel the unit distance is the same, the energy use efficiency used by the determination process is quantified such that the energy use efficiency has a higher value in a case in which the vehicle is traveling on a general road than in a case in which the vehicle is traveling on an expressway. Thus, even if the user drives on general roads relatively frequently, the energy use efficiency is unlikely to fail to meet the predetermined standard solely due to the frequent driving on general roads.

In a second general aspect, an in-vehicle device is employed in a vehicle efficiency evaluation system. The vehicle efficiency evaluation system preferably includes a first execution device mounted on a vehicle and a second execution device that is an out-of-vehicle device. The first execution device is configured to execute: an obtaining process that obtains a consumption variable, which is related to energy consumption of the vehicle, and a traveled distance variable, which is related to a traveled distance of the vehicle; and a variable transmitting process that transmits, to outside of the vehicle, an efficiency variable that corresponds to the consumption variable and the traveled distance variable, together with an identification variable of a user. The second execution device is configured to execute: a variable receiving process that receives the efficiency variable and the identification variable; a determination process that determines, on a basis of the efficiency variable, whether an energy use efficiency of the user identified by the identification variable meets a predetermined standard; and a reward-providing process that provides a reward to the user identified by the identification variable when the energy use efficiency of the user meets the predetermined standard. The in-vehicle device includes the first execution device.

In a third general aspect, a management execution device is employed in a vehicle efficiency evaluation system. The vehicle efficiency evaluation system includes a first execution device mounted on a vehicle and a second execution device that is an out-of-vehicle device. The first execution device is configured to execute: an obtaining process that obtains a consumption variable, which is related to energy consumption of the vehicle, and a traveled distance variable, which is related to a traveled distance of the vehicle; and a variable transmitting process that transmits, to outside of the vehicle, an efficiency variable that corresponds to the consumption variable and the traveled distance variable, together with an identification variable of a user. The second execution device is configured to execute: a variable receiving process that receives the efficiency variable and the identification variable; a determination process that determines, on a basis of the efficiency variable, whether an energy use efficiency of the user identified by the identification variable meets a predetermined standard; and a reward-providing process that provides a reward to the user identified by the identification variable when the energy use efficiency of the user meets the predetermined standard. The reward-providing process includes a notification process that notifies the user that a billing amount of an object provided to the user is discounted and a reason for the discount. The provided object includes at least one of a product or a service. The second execution device includes the management execution device, which is an execution device included as part of a vehicle group managing device, and a terminal execution device mounted in a portable terminal of the user. The notification process includes a displaying process that operates a display unit of the portable terminal to display a fact that a billing amount of a service provided to the user is discounted and a reason for the discount. The management execution device is configured to execute, at least: the variable receiving process that receives the efficiency variable and the identification variable transmitted by the variable transmitting process in each of multiple vehicles; the determination process; and a result transmitting process that transmits data related to a determination result of the determination process. The terminal execution device is configured to execute, at least: a result receiving process that receives the data transmitted by the result transmitting process; and the displaying process.

With the above-described configuration, the use of the portable terminal allows the reward-providing process to be implemented without requiring higher specifications of the in-vehicle devices.

In a fourth general aspect, a management execution device is employed in a vehicle efficiency evaluation system. The vehicle efficiency evaluation system includes a first execution device mounted on a vehicle and a second execution device that is an out-of-vehicle device. The first execution device is configured to execute: an obtaining process that obtains a consumption variable, which is related to energy consumption of the vehicle, and a traveled distance variable, which is related to a traveled distance of the vehicle; and a variable transmitting process that transmits, to outside of the vehicle, an efficiency variable that corresponds to the consumption variable and the traveled distance variable, together with an identification variable of a user. The second execution device is configured to execute: a variable receiving process that receives the efficiency variable and the identification variable; a determination process that determines, on a basis of the efficiency variable, whether an energy use efficiency of the user identified by the identification variable meets a predetermined standard; and a reward-providing process that provides a reward to the user identified by the identification variable when the energy use efficiency of the user meets the predetermined standard. The second execution device is configured to execute a software providing process that provides an updated version of software to the vehicle. The reward-providing process includes a process that advances a time point of providing the software by the software providing process as compared to a user of whom the energy use efficiency is determined to fail to meet the predetermined standard. The first execution device is configured to execute a software receiving process that receives the software provided by the software providing process. The second execution device includes the management execution device, which is an execution device included as part of a vehicle group managing device, and a terminal execution device mounted in a portable terminal of the user. The reward-providing process includes a displaying process that operates a display unit of the portable terminal to display a fact that a time point at which the updated version of the software is provided is advanced, and a reason for the advancement of the time point. The management execution device is configured to execute, at least: the variable receiving process that receives the efficiency variable and the identification variable transmitted by the variable transmitting process in each of multiple vehicles; the determination process; and a result transmitting process that transmits data related to a determination result of the determination process. The terminal execution device is configured to execute, at least: a result receiving process that receives the data transmitted by the result transmitting process; and the displaying process.

With the above-described configuration, the use of the portable terminal allows the reward-providing process to be implemented without requiring higher specifications of the in-vehicle devices.

In a fifth general aspect, an application program is employed in a vehicle efficiency evaluation system and executed by a portable terminal of a user. The vehicle efficiency evaluation system includes a first execution device mounted on a vehicle, and a second execution device that is an out-of-vehicle device. The first execution device is configured to execute: an obtaining process that obtains a consumption variable, which is related to energy consumption of the vehicle, and a traveled distance variable, which is related to a traveled distance of the vehicle; and a variable transmitting process that transmits, to outside of the vehicle, an efficiency variable that corresponds to the consumption variable and the traveled distance variable, together with an identification variable of a user. The second execution device is configured to execute: a variable receiving process that receives the efficiency variable and the identification variable; a determination process that determines, on a basis of the efficiency variable, whether an energy use efficiency of the user identified by the identification variable meets a predetermined standard; and a reward-providing process that provides a reward to the user identified by the identification variable when the energy use efficiency of the user meets the predetermined standard. The reward-providing process includes a notification process that notifies the user that a billing amount of an object provided to the user is discounted and a reason for the discount. The provided object includes at least one of a product or a service. The second execution device includes the management execution device, which is an execution device included by a vehicle group managing device, and a terminal execution device mounted in a portable terminal of the user. The notification process includes a displaying process that operates a display unit of the portable terminal to display a fact that a billing amount of a service provided to the user is discounted and a reason for the discount. The management execution device is configured to execute, at least: the variable receiving process that receives the efficiency variable and the identification variable transmitted by the variable transmitting process in each of multiple vehicles; the determination process; and a result transmitting process that transmits data related to a determination result of the determination process. The terminal execution device is configured to execute, at least: a result receiving process that receives the data transmitted by the result transmitting process; and the displaying process. The application program is configured to cause the portable terminal to execute the result receiving process and the displaying process.

Other features and aspects will be apparent from the following detailed description, the drawings, and the claims.

### BRIEF DESCRIPTION OF THE DRAWINGS

FIG. 1 is a diagram showing a vehicle efficiency evaluation system according to an embodiment of the present disclosure.

FIG. 2 is a flowchart showing the procedure of processes executed by a controller in a vehicle.

FIG. 3 is a flowchart showing a procedure of processes executed by a vehicle group managing device.

FIGS. 4A to 4C are flowcharts showing a procedure of processes executed by the vehicle efficiency evaluation system.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

A vehicle efficiency evaluation system according to an embodiment will now be described with reference to the drawings.

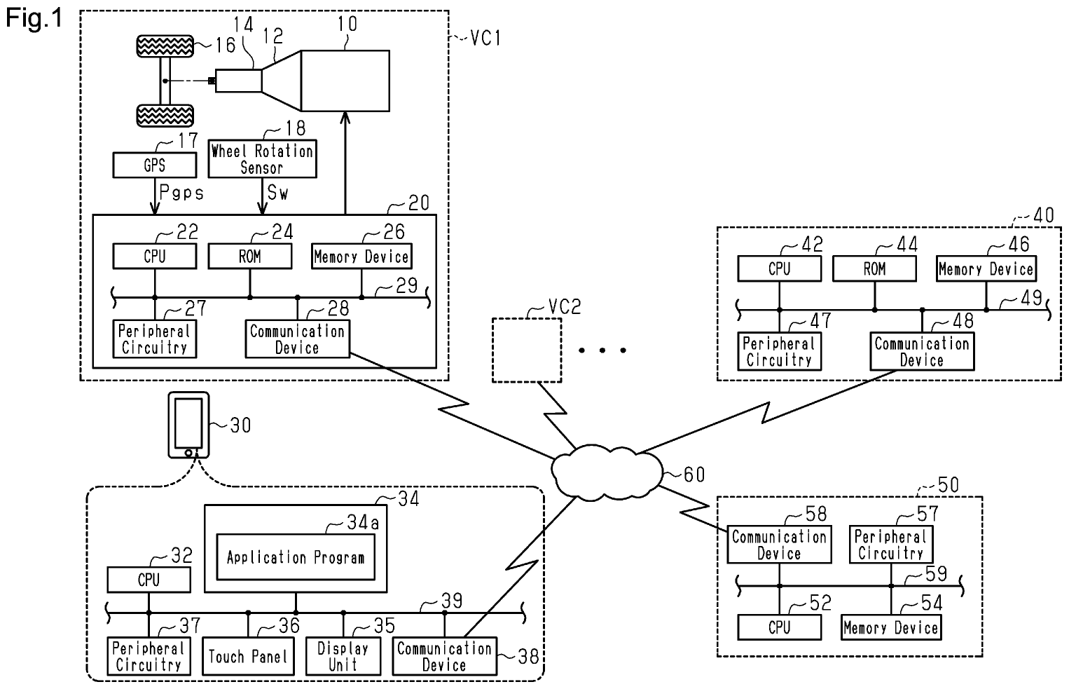

As shown in FIG. 1, a vehicle VC1 includes an internal combustion engine 10. Rotational force of the internal combustion engine 10 is transmitted to driven wheels 16 via a toque converter 12 and a transmission 14. The vehicle VC1 is equipped with a controller 20. The controller 20 controls the internal combustion engine 10. The controller 20 operates operated units of the internal combustion engine 10, such as a fuel injection valve, thereby controlling, for example, the torque and the ratios of exhaust components. The controller 20 receives positional data Pgps output by a global positioning system (GPS 17) and an output signal Sw of a wheel rotation sensor 18, which detects a rotation angle of the driven wheels 16.

The controller 20 includes a CPU 22, a ROM 24, a nonvolatile memory that can be electrically rewritten (memory device 26), peripheral circuitry 27, and a communication device 28. The CPU 22, the ROM 24, the memory device 26, the peripheral circuitry 27, and the communication device 28 are connected together through a local network 29 to communicate with one another. The peripheral circuitry 27 includes a circuit that generates a clock signal regulating internal operations, a power supply circuit, and a reset circuit.

The user of the vehicle VC1 carries a portable terminal 30. The portable terminal 30 includes a CPU 32, a nonvolatile memory that can be electrically rewritten (memory device 34), a display unit 35, a touch panel 36, which is overlapped with the display unit 35, peripheral circuitry 37, and a communication device 38. The CPU 32, the memory device 34, the display unit 35, the touch panel 36, the peripheral circuitry 37, and the communication device 38 are connected together through a local network 39 to communicate with one another. The memory device 34 stores an application program 34a.

A vehicle group managing device 40 manages data transmitted from multiple vehicles VC1, VC2, . . . . The vehicle group managing device 40 includes a CPU 42, a ROM 44, a nonvolatile memory that can be electrically rewritten (memory device 46), peripheral circuitry 47, and a communication device 48. The CPU 42, the ROM 44, the memory device 46, the peripheral circuitry 47, and the communication device 48 are connected together through a local network 49 to communicate with one another.

A sales-repair facility terminal 50 is installed in a sales-repair facility, which is a sales facility and a repair shop for the vehicle VC1. The sales-repair facility terminal 50 includes a CPU 52, a nonvolatile memory that can be electrically rewritten (memory device 54), peripheral circuitry 57, and a communication device 58. The CPU 52, the memory device 54, the peripheral circuitry 57, and the communication device 58 are connected together through a local network 59 to communicate with one another.

The controller 20 is capable of communicating with the portable terminal 30, the vehicle group managing device 40, and the sales-repair facility terminal 50 through a network 60.

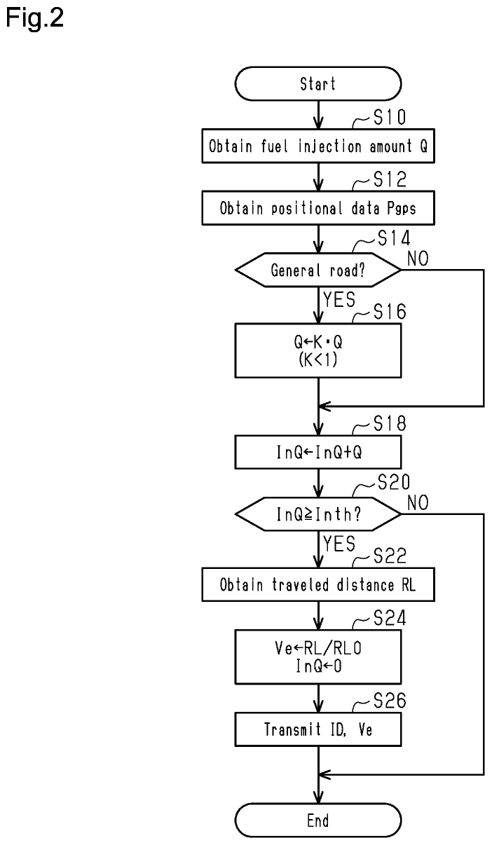

FIG. 2 shows a procedure of processes executed by the controller 20. The process shown in FIG. 2 is performed by the CPU 22 repeatedly executing programs stored in the ROM 24 at a predetermined interval.

As shown in FIG. 2, the CPU 22 first obtains an injection amount Q of the internal combustion engine 10 (S10). The CPU 22 then obtains the positional data Pgps (S12). On the basis of the positional data Pgps, the CPU 22 determines whether the road on which the vehicle VC1 is traveling is a general road (S14). In this case, the CPU 22 simply needs to determine whether one of the roads on the geographical map data stored in the memory device 26 that corresponds to the positional data Pgps is a general road. If the road on which the vehicle VC1 is traveling is a general road (S14: YES), the CPU 22 multiplies the injection amount Q by a predetermined coefficient K, which is less than 1, thereby correcting the injection amount Q (S16). The coefficient K is used to compensate for variation of the amount of fuel consumption due to causes other than the driving skills and the driving habit of the user. The deceleration operation is performed more frequently while traveling on a general road than on an expressway. Accordingly, the injection amount Q required to travel the same distance is larger on a general road than on an expressway. The coefficient K is set on the basis of this factor.

When the process of S16 is completed or when the determination is negative in the process of S14, the CPU 22 adds the injection amount Q to an injection integrated value InQ to update the injection integrated value InQ stored in the memory device 26 (S18). Next, the CPU 22 determines whether the injection integrated value InQ is greater than or equal to a threshold Inth (S20). When the injection integrated value InQ is greater than or equal to the threshold Inth (S20: YES), the CPU 22 obtains a traveled distance RL, which is the distance traveled by the vehicle VC1 during a period of time in which the injection integrated value InQ changes from zero to the threshold Inth (S22). The traveled distance RL is calculated by the CPU 22 on the basis of the output signal Sw of the wheel rotation sensor 18.

The CPU 22 divides the traveled distance RL obtained in the process of S22 by a reference distance RL0 to calculate a fuel-economy variable Ve, and initializes the injection integrated value InQ (S24). The higher the energy use efficiency increases as the fuel-economy variable Ve increases. In this description, energy refers to thermal energy generated when fuel is completely burned. The energy use efficiency refers to the ratio of the part of the thermal energy that is used to drive the vehicle VC1.

Then, the CPU 22 operates the communication device 28 to transmit identification information ID of the user of the vehicle VC1 and the fuel-economy variable Ve to the vehicle group managing device 40 via the network 60 (S26).

When the process of S26 is completed or when the determination is negative in the process of S20, the CPU 22 temporarily suspends the series of processes shown in FIG. 2.

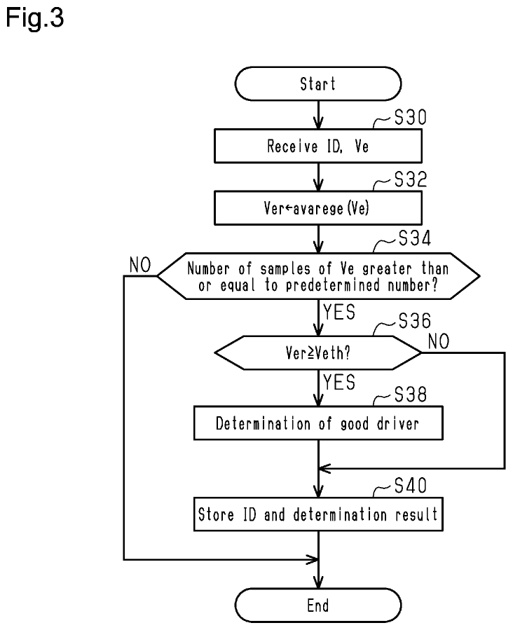

FIG. 3 shows a procedure of processes executed by the vehicle group managing device 40. The processes shown in FIG. 3 are performed by the CPU 42 repeatedly executing programs stored in the ROM 44 at a predetermined interval.

In the series of processes shown in FIG. 3, the CPU 42 receives the identification information ID and the fuel-economy variable Ve (S30). Next, the CPU 42 updates a determination fuel-economy variable Ver with the fuel-economy variable Ve, which has been newly received in the process of S30 (S32). The memory device 46 stores multiple values of the fuel-economy variable Ve. Some of the stored values are associated with the identification information ID. The determination fuel-economy variable Ver is the average of those associated values. This process is performed by storing, in the memory device 46, the number of times the fuel-economy variable Ve is received in the process of S30, multiplying the determination fuel-economy variable Ver by the stored number of times, adding the product to a newly received value of the fuel-economy variable Ve, and dividing the sum by the value obtained by adding 1 to the stored number of times. Instead, the process may be performed by updating the determination fuel-economy variable Ver with an exponential moving average process value of the stored values of the determination fuel-economy variable Ver and the newly received value of the fuel-economy variable Ve.

Next, the CPU 42 determines whether the number of samples of the fuel-economy variable Ve has become greater than or equal to a predetermined value. The number of samples of the fuel-economy variable Ve is the number of times the fuel-economy variable Ve associated with the identification information ID has been received in the process of S30 (S34). This process determines whether the determination fuel-economy variable Ver is highly reliable as a value that represents the driving habits of the user identified by the identification information ID.

When the number of samples of the fuel-economy variable Ve is greater than or equal to the predetermined value (S34: YES), the CPU 42 determines whether the determination fuel-economy variable Ver is greater than or equal to a reference value Veth (S36). The reference value Veth is the lower limit of the range of the determination fuel-economy variable Ver in the case of a good driver who drives a vehicle with a high fuel use efficiency. When the determination fuel-economy variable Ver is greater than or equal to the reference value Veth (S36: YES), the CPU 42 determines that the user is a good driver (S38).

When the process of S38 is completed or when the determination is negative in the process of S36, the CPU 32 stores, in the memory device 46, the identification information ID and the determination result indicating whether the user identified by the identification information ID is a good driver (S40). If the memory device 46 already has the determination result regarding the user identified by the identification information ID, the CPU 32 simply needs to update the determination result stored in the memory device 46 with the determination result of the current process.

When the process of S40 is completed or when the determination is negative in the process of S34, the CPU 42 temporarily suspends the series of processes shown in FIG. 3.

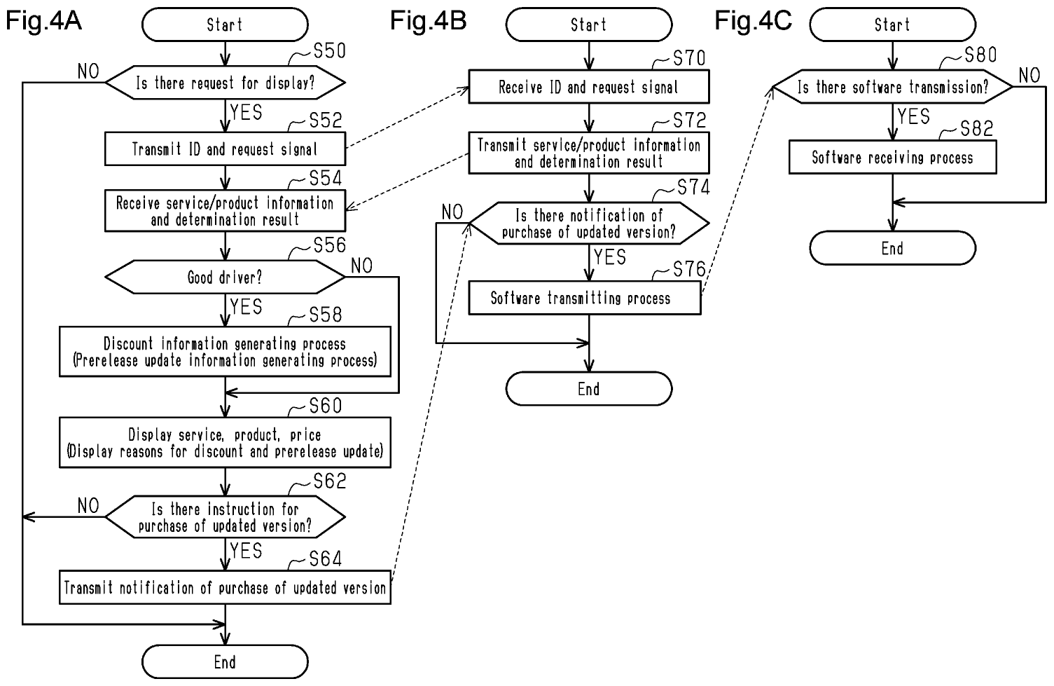

FIGS. 4A to 4C show a procedure for providing a reward to a user who has been determined to be a good driver. The process shown in FIG. 4A is implemented by the CPU 32 repeatedly executing the application program 34a stored in the memory device 34 of the portable terminal 30 at predetermined intervals. The process shown in FIG. 4B is implemented by the CPU 42 repeatedly executing a program stored in the ROM 44 of the vehicle group managing device 40 at predetermined intervals. The process shown in FIG. 4C is implemented by the CPU 22 repeatedly executing a program stored in the ROM 24 of the controller 20 at predetermined intervals. The procedure in which the user purchases a product or a service will be described with reference to the processes shown in FIGS. 4A to 4C according to the temporal sequence.

As shown in FIG. 4A, the CPU 32 determines that a request for display of a product or a service has been made through manipulation of the touch panel 36 by the user (S50: YES). Then, the CPU 32 operates the communication device 38 to transmit the identification information ID of the user of the portable terminal 30 and a request signal requesting display of the product and the service to the vehicle group managing device 40 (S52).

As shown in FIG. 4B, the CPU 42 receives the identification information ID and the request signal (S70). The CPU 42 then operates the communication device 48 to transmit, to the source of the data received in the process of S70, information related to the product and the service, and the above-described determination result related to the user identified by the identification information ID (S72). The information related to the product and the service includes information about the billing amounts of the product and the service, which are, for example, the fee of the service and the price of the product.

As shown in FIG. 4A, the CPU 32 receives the transmitted information related to the produce and the service and the determination result (S54). Then, the CPU 32 determines whether the received determination result indicates that the user is a good driver (S56). If the result indicates that the user is a good driver (S56: YES), the CPU 32 generates discount information for the transmitted product and service (S58). That is, in the present embodiment, the application program 34a includes an instruction for calculation of a billing amount discounted for a good driver. The CPU 32 calculates a discounted billing amount in accordance with the instruction. If there is a latest updated version of a software that is yet to be released to the public, the CPU 32 generates, as the information related to the service, display information indicating that an updated version can be purchased prior to the release.

The CPU 32 operates the display unit 35 of the portable terminal 30 to display the billing amount of the service and the product (S60). At this time, the CPU 32 displays, when it is the case, that the software can be purchased prior to the release or that the billing amount is discounted, with the reasons.

The CPU 32 then determines whether purchase of the updated version of the software has been instructed through manipulation of the touch panel 36 (S62). If purchase of the updated version of the software has been instructed (S62: YES), the CPU 32 operates the communication device 38 to notify the vehicle group managing device 40 that the user has an intention to purchase the software (S64). When the process of S64 is completed or when the determination is negative in the processes of S50, S62, the CPU 32 temporarily suspends the series of processes shown in FIG. 4A.

A shown in FIG. 4B, the CPU 42 determines whether the user has an intention to purchase the updated version of the software (S74). Whether the user has an intention to purchase the updated version of the software is determined on the basis of whether the user has actually determined to purchase it and manipulated the touch panel 36 to make a payment. If the user has an intention to purchase the updated version of the software (S74: YES), the CPU 42 operates the communication device 48 to transmit, to the vehicle VC1 identified by the identification information ID, the version of the software for which the decision of purchase has been received (S76). When the process of S76 is completed or when the determination is negative in the process of S74, the CPU 42 temporarily suspends the series of processes shown in FIG. 4B.

A shown in FIG. 4C, the CPU 22 determines whether the software has been transmitted from the vehicle group managing device 40 (S80). When the software is transmitted from the vehicle group managing device 40 (S80: YES), the CPU 22 receives the transmitted software (S82). When the process of S82 is completed or when the determination is negative in the process of S80, the CPU 22 temporarily suspends the series of processes shown in FIG. 4C.

The vehicle group managing device 40 operates the communication device 48 to transmit, to the sales-repair facility terminal 50, the identification information ID that identifies the user who has been determined to be a good driver, and the determination result indicating that the user is a good driver. The CPU 52 in the sales-repair facility terminal 50 stores, in the memory device 54, the identification information ID and the determination result indicating that the user is a good driver. When the user, who has been determined to be a good driver, visits the facility where the sales-repair facility terminal 50 is installed to purchase a product or a service, the billing amount is discounted.

An operation and advantages of the present embodiment will now be described.

The vehicle group managing device 40 calculates the determination fuel-economy variable Ver for each of the vehicles VC1, VC2, . . . . When the determination fuel-economy variable Ver is greater than or equal to the reference value Veth, the user is determined to be a good driver. A good driver is provided with a reward for performing driving of a high energy use efficiency. For example, the vehicle group managing device 40 provides a good driver with a product and a service for discounted prices. This offers an incentive of encouragement of the user to drive with a high energy use efficiency.

The present embodiment further has the following operations and advantages.

(1) The CPU 42 stores the identification information ID and the determination result in the memory device 46. The identification information ID is information that identifies the user of the vehicle VC1, not the vehicle VC1. Thus, even if the vehicle owned by the user identified by the predetermined identification information ID is changed from the vehicle VC1 to another vehicle due to replacement purchase, the memory device 46 maintains the evaluation result obtained when the user was driving the vehicle VC1. Therefore, if the user was determined to be a good driver prior to the replacement purchase of a vehicle, the user retains the evaluation made prior to the replacement purchase, even after the replacement purchase. This allows the user to receive rewards such as discounted prices of products and services.

(2) An integrated value of the injection amount Q is not used as the injection integrated value InQ. Instead, the injection amount Q during driving on a general road is reduced using the coefficient K, and the integrated value of the reduced value is used as the injection integrated value InQ. This prevents the determination fuel-economy variable Ver from being greater than or equal to the reference value Veth solely due to relatively frequent driving on general roads.

<Correspondence>

The correspondence between the items in the above embodiments and the items the WHAT IS CLAIMED IS section is as follows. Below, the correspondence is shown for each claim number.

[1, 5] The first execution device corresponds to the CPU 22 and the ROM 24. The second execution device corresponds to the CPUs 32, 42, 52, the ROM 44, and the memory devices 34, 54. The consumption variable corresponds to the injection integrated value InQ. The traveled distance variable corresponds to the traveled distance RL. The efficiency variable corresponds to the fuel-economy variable Ve. The variable transmitting process corresponds to the process of S26. The variable receiving process corresponds to the process of S30. The determination process corresponds to the process of S36. The reward-providing process corresponds to the processes of S56 to S64, and S72 to S76.

[2] The notification process corresponds to the process of S60.

[3] The software providing process corresponds to the process of S76, and the software receiving process corresponds to the process of S82.

[4] The software providing process and the software receiving process respectively correspond to the process of S76 and the process of S82 in a case in which prerelease update information is generated in the process of S58.

[6] The identifying process corresponds to the process of S14.

[7] The in-vehicle device corresponds to the controller 20.

[8, 9] The management execution device corresponds to the CPU 42 and the ROM 44. The terminal execution device corresponds to the CPU 32 and the memory device 34. The displaying process corresponds to the process of S60. The result transmitting process corresponds to the process of S72. The result receiving process corresponds to the process of S54.

[10] Claim 10 corresponds to the application program 34a.

<Other Embodiments>

The above-described embodiment may be modified as follows. The above-described embodiment and the following modifications can be combined as long as the combined modifications remain technically consistent with each other.

Regarding Consumption Variable

In a case of an electric vehicle as described in the Regarding Vehicle section, the consumption of power of the battery simply needs to be used as the consumption variable.

In a case of a hybrid vehicle as described in the Regarding Vehicle section, reduction in the power of the battery may be converted into fuel consumption by multiplying the consumption of the power by a conversion coefficient that converts consumption of power to fuel consumption. In this case, the consumption variable includes a variable related to the fuel consumption. Conversely, reduction in fuel may be converted into the power consumption by multiplying the fuel consumption by a conversion coefficient that converts fuel consumption to power consumption. In this case, the consumption variable includes a variable related to the power consumption.

Regarding Efficiency Variable

In the above-described embodiment, the fuel-economy variable Ve is transmitted from the vehicle VC1 to the vehicle group managing device 40. However, the efficiency variable, which corresponds to the consumption variable and the traveled distance variable and is transmitted to the vehicle group managing device 40, is not limited to the fuel-economy variable Ve. For example, the efficiency variable may be a mere combination of the consumption variable and the traveled distance variable. In that case, the vehicle group managing device 40 simply needs to execute processes similar to the processes of S20, S24 to calculate the fuel-economy variable Ve.

Regarding Determination Process

In the above-described embodiment, whether the determination fuel-economy variable Ver is greater than or equal to the single reference value Veth is determined. However, two or more reference values may be used as values to be compared to the determination fuel-economy variable Ver. For example, users may be ranked into three or more good-driver levels on the basis of comparison between the determination fuel-economy variable Ver and each of reference values.

The energy use efficiency used in the determination process is not limited to the determination fuel-economy variable Ver. In a case in which an electric vehicle is used as described in the Regarding Vehicle section, an energy use efficiency, which is compared to a predetermined reference, simply needs to be quantified using the traveled distance per unit amount of charge of the battery.

Regarding Reward Providing Process

In a case in which users are ranked into three or more good-driver levels as in the Regarding Determination Process section, three or more price reduction ratios may be used in accordance with the good-driver level. The lowest value of the price reduction ratio is zero. Also, three or more time points to provide an updated version of software may be used in accordance with the good-driver level of the user. In a case in which users are ranked into three or more good-driver levels, it is not necessary to provide three or more price reduction ratios or three or more time points to provide the updated version of the software. That is, only users having the highest good-driver level may be provided with rewards such as a reduced billing amount or an early time point of receiving the software. Also, the users may be informed of their good-driver levels. Accordingly, a user who was determined to be at a low good-driver level receives an incentive to reach the highest good-driver level.

In the above-described embodiment, the reward-providing process does not necessarily include a process in which the prices of products or services sold or provided at the sales-repair facility terminal 50 are discounted.

In the above-described embodiment, the reward for a good driver includes prerelease update of paid software. In addition to this, the reward may include prerelease update of free software. In this case, the reward does not necessarily include prerelease update of paid software.

While including discounted prices of products and services, the reward for a good driver does not necessarily include prerelease update of paid software. Also, while including prerelease update of paid software, the reward for a good driver does not necessarily include discounted prices of products and services.

In a case in which software is installed in a vehicle as an option as described in the Regarding Software Providing Process section, the reward for a good driver may include discount of the amount for purchasing the software.

Regarding Notification Process

The above-described embodiment generates the display information on the basis of the price reduction ratio defined by the application program 34a when the process of S72 transmits the determination result indicating that the user is a good driver. The present disclosure is not limited to this. For example, the process of S72 may also transmit information of the price reduction ratio. That is, in place of transmitting, to the portable terminal 30, information regarding a discount and the reasons for the discount through cooperation of the process of step S72 and the process that transmits the application program 34a to the portable terminal 30, the process of S72 may perform the transmission alone.

In the above-described embodiment, the process of S72 transmits information to the portable terminal 30. However, the process of S72 may transmit information to the vehicle VC1. In that case, the process of S72 is regarded as the notification process, and the controller 20 performs the process of displaying the transmitted information on the in-vehicle display device.

Regarding Software Providing Process

The process of providing software that can be used in the vehicle is not limited to transmission of the software to the vehicle. For example, software as an option may be installed in the vehicle in advance, and may become usable only when the user completes the purchase.

Regarding Vehicle Control System

The vehicle efficiency evaluation system does not necessarily include all of the controller 20, the portable terminal 30, the vehicle group managing device 40, and the sales-repair facility terminal 50. For example, the vehicle efficiency evaluation system may include only the controller 20, the portable terminal 30, and the vehicle group managing device 40. Also, the vehicle efficiency evaluation system may include only the controller 20 and the vehicle group managing device 40.

Regarding Execution Device

The execution device is not limited to a device that includes the CPU 22 (42) and the ROM 24 (44) and executes software processing, or to a device that includes the CPU 32 (52) and the memory device 34 (54) and executes software processing. For example, at least part of the processes executed by the software in the above-described embodiment may be executed by hardware circuits dedicated to executing these processes (such as an application-specific integrated circuit (ASIC)). That is, the execution device may be modified as long as it has any one of the following configurations (a) to (c). (a) A configuration including a processor that executes all of the above-described processes according to programs and a program storage device such as a ROM that stores the programs. (b) A configuration including a processor and a program storage device that execute part of the above-described processes according to the programs and a dedicated hardware circuit that executes the remaining processes. (c) A configuration including a dedicated hardware circuit that executes all of the above-described processes. Multiple software processing devices each including a processor and a program storage device and multiple dedicated hardware circuits may be provided.

Regarding Vehicle

The vehicle is not limited to a vehicle that includes only an internal combustion engine as a propelling force generator, but may be a hybrid vehicle that includes an internal combustion engine and a rotating electric machine. The vehicle may be a hybrid vehicle that includes a rotating electric machine as the propelling force generator, and includes an internal combustion engine. The vehicle may be a plug-in hybrid vehicle, of which the battery can charged with power from outside. Further, the vehicle may be an electric vehicle or a fuel cell vehicle that includes a rotating electric machine, but does not include an internal combustion engine.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. A vehicle efficiency evaluation system comprising:
a first execution device mounted on a vehicle, and
a second execution device that is an out-of-vehicle device, wherein
the first execution device is configured to execute
an obtaining process that obtains a consumption variable, which is related to energy consumption of the vehicle, and a traveled distance variable, which is related to a traveled distance of the vehicle, and
a variable transmitting process that transmits, to outside of the vehicle, an efficiency variable that corresponds to the consumption variable and the traveled distance variable, together with an identification variable of a user, and the second execution device is configured to execute
a variable receiving process that receives the efficiency variable and the identification variable,
a determination process that determines, on a basis of the efficiency variable, whether an energy use efficiency of the user identified by the identification variable meets a predetermined standard, and
a reward-providing process that provides a reward to the user identified by the identification variable when the energy use efficiency of the user meets the predetermined standard.

2. The vehicle efficiency evaluation system according to claim 1, wherein
the reward-providing process includes a notification process that notifies the user that a billing amount of an object provided to the user is discounted and a reason for the discount, and
the provided object includes at least one of a product or a service.

3. The vehicle efficiency evaluation system according to claim 2, wherein
the second execution device is configured to execute a software providing process that provides software to the vehicle,
the reward-providing process includes a process that discounts a billing amount of the software, and
the first execution device is configured to execute a software receiving process that receives the software provided by the software providing process.

4. The vehicle efficiency evaluation system according to claim 1, wherein
the second execution device is configured to execute a software providing process that provides an updated version of software to the vehicle,
the reward-providing process includes a process that advances a time point of providing the software by the software providing process as compared to a user of whom the energy use efficiency is determined to fail to meet the predetermined standard, and
the first execution device is configured to execute a software receiving process that receives the software provided by the software providing process.

5. The vehicle efficiency evaluation system according to claim 1, wherein
the second execution device is configured to execute a storing process that stores a combination of a determination result and the identification variable in a memory device when the energy use efficiency of the user meets the predetermined condition,
the reward-providing process provides a reward on a basis of the determination result stored in the memory device, and
the determination result stored in the memory device is associated with the user even when the user changes vehicles.

6. The vehicle efficiency evaluation system according to claim 1, wherein
the obtaining process includes an identifying process that identifies whether a road on which the vehicle is traveling is a general road or an expressway, and
if an amount of energy required for the vehicle to travel a unit distance is the same, the energy use efficiency is higher in a case in which the vehicle is traveling on a general road than in a case in which the vehicle is traveling on an expressway.

7. An in-vehicle device employed in a vehicle efficiency evaluation system, wherein
the vehicle efficiency evaluation system includes a first execution device mounted on a vehicle and a second execution device that is an out-of-vehicle device,
the first execution device is configured to execute
an obtaining process that obtains a consumption variable, which is related to energy consumption of the vehicle, and a traveled distance variable, which is related to a traveled distance of the vehicle, and
a variable transmitting process that transmits, to outside of the vehicle, an efficiency variable that corresponds to the consumption variable and the traveled distance variable, together with an identification variable of a user, the second execution device is configured to execute
a variable receiving process that receives the efficiency variable and the identification variable,
a determination process that determines, on a basis of the efficiency variable, whether an energy use efficiency of the user identified by the identification variable meets a predetermined standard, and
a reward-providing process that provides a reward to the user identified by the identification variable when the energy use efficiency of the user meets the predetermined standard, and
the in-vehicle device comprises the first execution device.

8. A management execution device employed in a vehicle efficiency evaluation system, wherein
the vehicle efficiency evaluation system includes a first execution device mounted on a vehicle and a second execution device that is an out-of-vehicle device,
the first execution device is configured to execute
an obtaining process that obtains a consumption variable, which is related to energy consumption of the vehicle, and a traveled distance variable, which is related to a traveled distance of the vehicle, and
a variable transmitting process that transmits, to outside of the vehicle, an efficiency variable that corresponds to the consumption variable and the traveled distance variable, together with an identification variable of a user, the second execution device is configured to execute
a variable receiving process that receives the efficiency variable and the identification variable,
a determination process that determines, on a basis of the efficiency variable, whether an energy use efficiency of the user identified by the identification variable meets a predetermined standard, and
a reward-providing process that provides a reward to the user identified by the identification variable when the energy use efficiency of the user meets the predetermined standard,
the reward-providing process includes a notification process that notifies the user that a billing amount of an object provided to the user is discounted and a reason for the discount,
the provided object includes at least one of a product or a service,
the second execution device includes
the management execution device, which is an execution device included as part of a vehicle group managing device, and
a terminal execution device mounted in a portable terminal of the user,
the notification process includes a displaying process that operates a display unit of the portable terminal to display a fact that a billing amount of a service provided to the user is discounted and a reason for the discount,
the management execution device is configured to execute, at least,
the variable receiving process that receives the efficiency variable and the identification variable transmitted by the variable transmitting process in each of multiple vehicles,
the determination process, and
a result transmitting process that transmits data related to a determination result of the determination process, and
the terminal execution device is configured to execute, at least,
a result receiving process that receives the data transmitted by the result transmitting process, and
the displaying process.

9. A management execution device employed in a vehicle efficiency evaluation system, wherein
the vehicle efficiency evaluation system includes a first execution device mounted on a vehicle and a second execution device that is an out-of-vehicle device,
the first execution device is configured to execute
an obtaining process that obtains a consumption variable, which is related to energy consumption of the vehicle, and a traveled distance variable, which is related to a traveled distance of the vehicle, and
a variable transmitting process that transmits, to outside of the vehicle, an efficiency variable that corresponds to the consumption variable and the traveled distance variable, together with an identification variable of a user, the second execution device is configured to execute
a variable receiving process that receives the efficiency variable and the identification variable,
a determination process that determines, on a basis of the efficiency variable, whether an energy use efficiency of the user identified by the identification variable meets a predetermined standard, and
a reward-providing process that provides a reward to the user identified by the identification variable when the energy use efficiency of the user meets the predetermined standard,
the second execution device is configured to execute a software providing process that provides an updated version of software to the vehicle,
the reward-providing process includes a process that advances a time point of providing the software by the software providing process as compared to a user of whom the energy use efficiency is determined to fail to meet the predetermined standard,
the first execution device is configured to execute a software receiving process that receives the software provided by the software providing process,
the second execution device includes
the management execution device, which is an execution device included as part of a vehicle group managing device, and
a terminal execution device mounted in a portable terminal of the user,
the reward-providing process includes a displaying process that operates a display unit of the portable terminal to display a fact that a time point at which the updated version of the software is provided is advanced, and a reason for the advancement of the time point,
the management execution device is configured to execute, at least,
the variable receiving process that receives the efficiency variable and the identification variable transmitted by the variable transmitting process in each of multiple vehicles,
the determination process, and
a result transmitting process that transmits data related to a determination result of the determination process, and
the terminal execution device is configured to execute, at least,
a result receiving process that receives the data transmitted by the result transmitting process, and
the displaying process.

10. An application program employed in a vehicle efficiency evaluation system and executed by a portable terminal of a user, wherein
the vehicle efficiency evaluation system includes
a first execution device mounted on a vehicle, and
a second execution device that is an out-of-vehicle device,
the first execution device is configured to execute
an obtaining process that obtains a consumption variable, which is related to energy consumption of the vehicle, and a traveled distance variable, which is related to a traveled distance of the vehicle, and
a variable transmitting process that transmits, to outside of the vehicle, an efficiency variable that corresponds to the consumption variable and the traveled distance variable, together with an identification variable of a user,
the second execution device is configured to execute
a variable receiving process that receives the efficiency variable and the identification variable,
a determination process that determines, on a basis of the efficiency variable, whether an energy use efficiency of the user identified by the identification variable meets a predetermined standard, and
a reward-providing process that provides a reward to the user identified by the identification variable when the energy use efficiency of the user meets the predetermined standard,
the reward-providing process includes a notification process that notifies the user that a billing amount of an object provided to the user is discounted and a reason for the discount,
the provided object includes at least one of a product or a service,
the second execution device includes
the management execution device, which is an execution device included by a vehicle group managing device, and
a terminal execution device mounted in a portable terminal of the user,
the notification process includes a displaying process that operates a display unit of the portable terminal to display a fact that a billing amount of a service provided to the user is discounted and a reason for the discount,
the management execution device is configured to execute, at least,
the variable receiving process that receives the efficiency variable and the identification variable transmitted by the variable transmitting process in each of multiple vehicles,
the determination process, and
a result transmitting process that transmits data related to a determination result of the determination process,
the terminal execution device is configured to execute, at least,
a result receiving process that receives the data transmitted by the result transmitting process, and
the displaying process, and
the application program is configured to cause the portable terminal to execute the result receiving process and the displaying process.
